(19) United States
(12) Patent Application Publication
(10) Pub. No.: US 2026/0160880 A1
(43) Pub. Date: Jun. 11, 2026

(54) SYSTEM AND METHOD FOR IDENTIFYING STATIC ELEMENTS AT INFRASTRUCTURE USING RADAR DATA

(71) Applicant: Continental Automotive Systems, Inc., Auburn Hills, MI (US)

(72) Inventors: Ganesh Adireddy, Bloomfield Hills, MI (US); Pablo Arturo Martinez Gonzalez, San Luis Potosi (MX); Naveen Chilukoti, Troy, MI (US)

(73) Assignee: Continental Automotive Systems, Inc., Auburn Hills, MI (US)

(21) Appl. No.: 18/708,099

(22) PCT Filed: Nov. 10, 2022
(86) PCT No.: PCT/US2022/079622

§ 371 Date: May 7, 2024

Related U.S. Application Data
(60) Provisional application No. 63/263,995, filed on Nov. 12, 2021.

(51) Int. Cl. G01S 13/72; G01S 13/87; G01S 13/91; G08G 1/01

(52) U.S. Cl. CPC G01S 13/726; G01S 13/87; G01S 13/91; G08G 1/01

(57) ABSTRACT

A method and system for tracking objects in a geographical area having one or more roadways are disclosed. The method includes receiving a first set of sensor cluster data from a plurality of sensors mounted in the geographical area; constructing a heat map based on the sensor cluster data; identifying static regions of the heat map corresponding to static objects in the geographical area; storing information corresponding to the static regions in a data structure; receiving a second set of sensor cluster data from the plurality of sensors; determining whether sensor cluster data from the second set matches sensor data clusters corresponding to the static region in the data structure; upon an affirmative determination of a match, forming a subset of sensor cluster data from the second set which excludes the matched sensor cluster data from the second set; and tracking objects using the subset of sensor cluster data.

### FIELD OF INVENTION

The present invention generally relates to an intelligent intersection, and particularly to an intelligent intersection system in which permanently static objects are identified and removed from consideration by a target tracking routine.

### BACKGROUND

Intelligent intersection systems typically perform any of a variety of functions to facilitate the safe and efficient flow of traffic by vehicles, pedestrians and cyclists passing through a street intersection. Such a system may include sensors for sensing and classifying objects in and around the intersection, and data processing hardware for performing an intelligent intersection function based upon the sensed, classified objects. Example intelligent intersection functions include controlling traffic lights at the street intersection and detecting whether a traffic accident has occurred or may likely occur.

When using radars in an infrastructure setting, static elements at the infrastructure are often present in and around the roadway and cause the radar to observe persistent stationary reflections. These stationary reflections can interfere with the tracking of slow-moving objects which pass nearby. This results in poor object detection and tracking.

### BRIEF DESCRIPTION OF THE DRAWINGS

Aspects of the invention will be explained in detail below with reference to exemplary embodiments in conjunction with the drawings, in which:

FIG. 1 is a top view of a street intersection having an intelligent intersection system according to an example embodiment;

FIG. 2 is a schematic diagram of the intelligent intersection system of FIG. 1 according to an example embodiment;

FIG. 3 is a flowchart illustrating an intelligent intersection method, according to an example embodiment;

FIG. 4 is a block diagram of a computing device of the intelligent intersection system of FIG. 2, according to an example embodiment;

FIG. 5 is a top view of a portion of a street intersection with radar reflections appearing therein; and

FIG. 6 is a view of a portion of the street intersection of FIG. 5 in which reflections from static objects and reflections from a dynamic object appear in close proximity with each other.

### DETAILED DESCRIPTION

The following description of the example embodiments is merely exemplary in nature and is in no way intended to limit the invention, its application, or uses.

The example embodiments presented herein are generally directed to a system, software product and operating method for excluding radar cluster data pertaining to static structures during object tracking so that the radar cluster data does not interfere with the tracking of slowly moving objects nearby. A central processing unit (CPU) of the intelligent intersection system receives raw radar cluster data from a plurality of radar sensors disposed at the corresponding intersection. The CPU constructs a heat map based on the raw radar data cluster data, identifies static regions corresponding to static objects based on the heat map, stores the information concerning the static regions in a searchable data structure, and filters or removes subsequently received raw radar cluster data corresponding to the identified static regions from use during object tracking so as to reduce or eliminate interference with the tracking of relatively slowly moving object in the intersection.

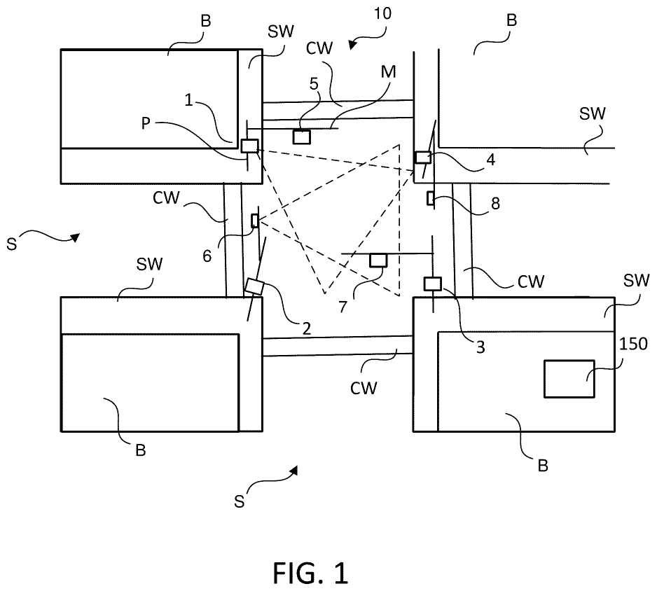

FIG. 1 illustrates a bird's eye view of a geographical area including an intersection of streets S bounded by city blocks B having sidewalk/curb areas SW and crosswalks CW. A plurality of traffic lights (not shown) are disposed on masts M that are supported by poles P (only one pole P and corresponding mast M are specifically identified for reasons of clarity). An infrastructure system 10 is disposed in and around the intersection. In this example embodiment, the intelligent intersection system 10 includes a plurality of radar sensors 1-8 facing the intersection of streets S. Each radar sensor 1-4 is mounted to a distinct pole P and each radar sensor 5-8 is mounted to a distinct mast M. Each pole-mounted radar sensor 1-4 faces the center of the intersection of streets S and each mast-mounted radar sensor faces the corresponding incoming street S. The field of view of radar sensor 1 and 6 are shown in dashed lines. It is understood that more or less than eight radar sensors may be used in association with an intersection of streets, and that the radar sensors may be mounted at different locations relative to the street intersection than on the poles P and masts M as illustrated in FIG. 1. In an implementation, one or more of the radar sensors 1-8 is a short range radar.

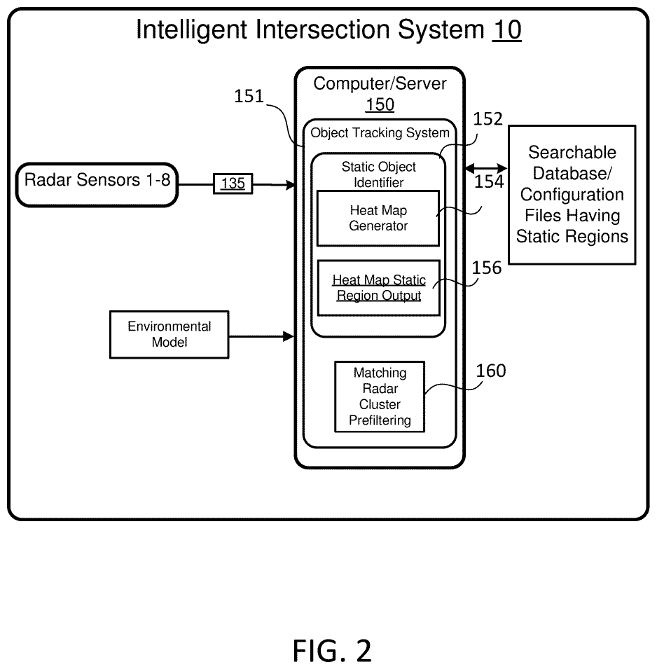

FIG. 2 illustrates a block diagram of the intelligent intersection system 10 according to an example embodiment. In addition to radar sensors 1-8, the system 10 includes a computer and/or server 150 (hereinafter simply “computer 150”). The computer 150 may be separate from the radar sensors 1-8 as depicted in FIG. 1. Alternatively, computer 150 may be part of one or more of the sensors 1-8. The computer 150 receives raw radar cluster data 135 from radar sensors 1-8. The computer 150 includes an object tracking system 151 which tracks objects in or around the intersection that are detected by the sensors 1-8. Objects tracked by the object tracking system 150 may be used by the intelligent intersection system 10 to, for example, control traffic flow through the intersection. The object tracking system 151 includes a static object identifier algorithm or module 152 which generally identifies static objects based on the received raw radar cluster data 135 received. The static object identifier 152 includes a heat map generator 154 which generates a heat map based on the raw radar cluster data 135. The heat map generated may include zero speed radar clusters, i.e., radar reflections from static objects that are permanently fixed objects in the intersection environment. Examples of such static objects include buildings, traffic lights, signs, etc. A rate of build and decay of heat index values of the heat map may be applied to accurately capture and/or identify objects that are static over a predetermined prolong period of time, such as a time period markedly greater than the amount of time a parked vehicle may be stationary near the intersection. For radar clusters that are static over the period of time, a confidence or heat index is built that the radar cluster corresponds to a static object at the intersection. If a radar cluster changes during the predetermined period of time, such as radar cluster data corresponding to a vehicle parked near the intersection that eventually leaves the area, then a confidence or heat index indicates that the radar cluster data corresponds to a non-static object, such as a slowly moving object.

A heat map static region output module 156 encapsulates the static regions of the generated heat map and outputs the static regions to a searchable data structure and/or configuration file. In one implementation, the data structure contains one or more of the range, angle, standard deviation and radar cross section of each static region with respect to each sensor 1-8 mounted in or around the intersection.

In one implementation, the object tracking system 151 tracks objects in part by creating an object list and/or environmental model which includes various attributes of objects detected by radar sensors 1-8. Once the collection of static regions have been identified, extracted and stored/archived in configuration files by the static object identifier 152, an environmental component/object of the environmental model loads the configuration file(s), and a radar cluster matching module 160 matches radar cluster data of the static regions in the configuration file with radar cluster data of the environmental component. A match between radar cluster data of a static region in the configuration file and radar cluster data of the environmental model component causes the matched environmental model component to be prefiltered so that the object tracking system 151 does not consider the component. As a result, radar cluster data corresponding to a previously determined static region is excluded for use by the object tracking system 151 so that a subset of the sensed radar cluster data used by the object tracking system 151 only includes radar cluster data corresponding to dynamic (i.e., moving) objects.

FIG. 2 depicts the static object identifier 152 being part of the object tracking system 151. It is understood that the static object identifier 152 may be separate from of the object tracking system 151. It is further understood that the object tracking system 151 includes other algorithms or modules for performing various functions corresponding to the monitoring and/or control of traffic in an intersection or along a roadway and that such functions are not described herein for reasons of simplicity.

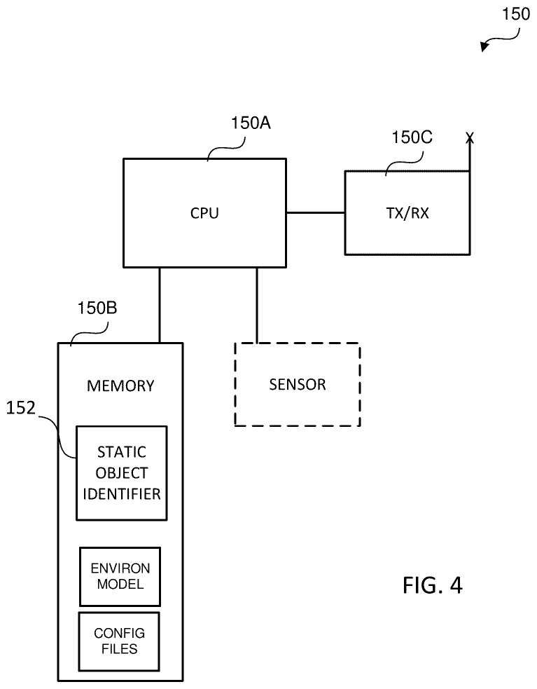

Referring to FIG. 4, in one implementation the computer 150 includes data processing hardware such as a central processing unit (CPU) 150A and non-transitory memory 150B coupled thereto. In one implementation, the memory 150B, which may include volatile and non-volatile memory, stores program code instructions which, when executed by CPU 150A, causes CPU 150A to perform one or more intelligent intersection functions or operations. In an example embodiment, the memory 150B maintains the static object identifier 152, the environmental model and the configuration files. The memory 150B may also maintain data, such as the raw radar data 135 received from radar sensors 1-8. A transceiver 150C is communicatively coupled to the CPU 150A for transmitting and receiving information over the air interface using any one or more of a number of existing or future wireless communication protocols. In an implementation, transceiver 150C receives the raw radar data 135 from radar sensors 1-8. In addition or in the alternative to communicating with radar sensors 108 over the air interface, the transceiver 150C also transmits and receives information over a hardwired connection using any known or future communication protocol for effectuating communication over the wired connection.

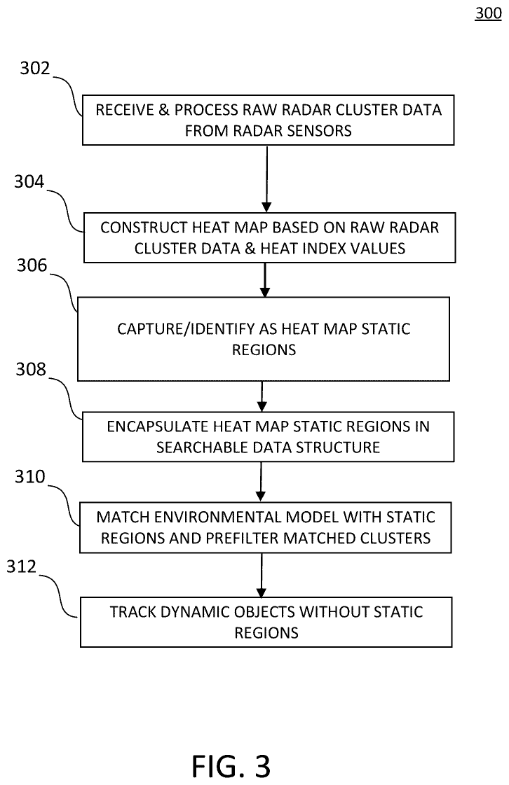

FIG. 3 illustrates a flowchart describing an operation 300 according to an example embodiment. At 302, the CPU 150A receives and processes a first set of raw radar cluster data from radar sensors 1-8. The CPU 150A generates at 304 a heat map based on the received raw radar cluster data, including static raw radar cluster data corresponding to static objects. Static regions (i.e., raw radar cluster data corresponding to static objects) are captured or otherwise identified at 306 based on the heat map. The static regions are saved in the searchable data structure or other configuration file at 308. Static region information/attributes stored in the data structure/configuration files includes range, angle, standard deviation and radar cross section in relation to each sensor 1-8.

With the searchable data structure/configuration files are created, it/they may then be used to identify subsequently detected radar clusters that correspond to static objects in a second set of radar cluster data. Specifically, an object in the environmental model/object list, which may be created as part of object tracking by the object tracking system 151, loads the configuration file(s) and the CPU 150A determines at 310 whether the radar cluster of the object matches any static region in the configuration file. An affirmative match causes the CPU 150A to prefilter the matched object so that the object tracking system 151 does not use the matched object. As a result, there is less or no interference by static objects with dynamic object tracking. The resulting subset of radar cluster data thus only includes radar cluster data corresponding to dynamic objects.

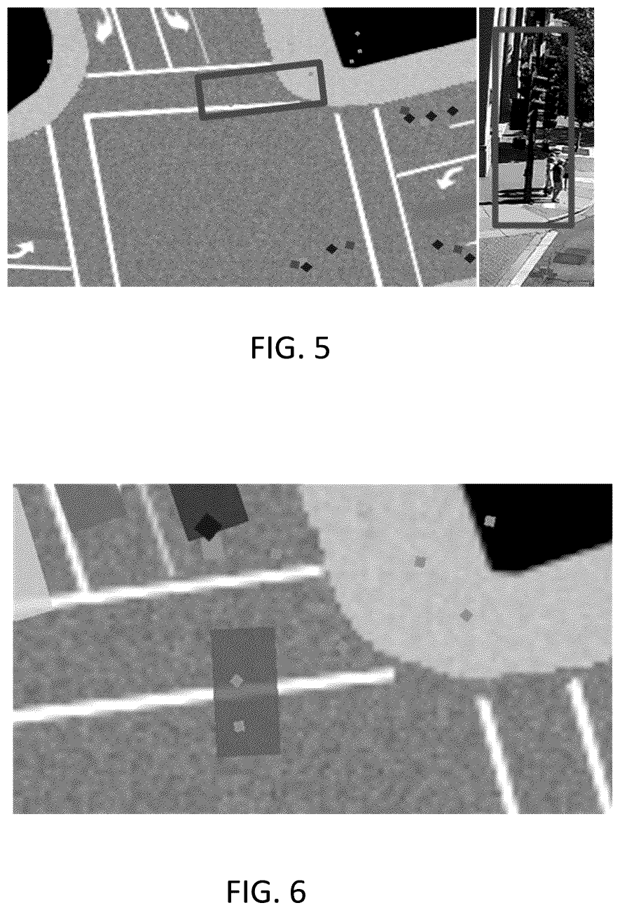

FIG. 5 is a top view of a portion of an intersection showing, on the left part of the image, radar reflections from radar sensors 1-8 (appearing as dots) which include radar reflections from static objects (located within the rectangle), such as a street light shown on the right part of the image. FIG. 6 is a top view illustrating radar reflections from the static objects along with reflections from a vehicle passing through the intersection beneath the static streel light, which shows how both dynamic reflections (from the vehicle) and static reflections from static objects can be located in the same area, thereby leading to interference by the static reflections when tracking reflections by the moving vehicle.

Various implementations of the systems and techniques described here may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification may be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus or CPU. The computer readable medium or memory man be a machine-readable storage device, a machine-readable storage substrate, a memory device, a composition of matter effecting a machine-readable propagated signal, or a combination of one or more of them. The terms “data processing apparatus”, “computing device”, and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The example embodiments have been described herein in an illustrative manner, and it is to be understood that the terminology which has been used is intended to be in the nature of words of description rather than of limitation. Obviously, many modifications and variations of the invention are possible in light of the above teachings. The description above is merely exemplary in nature and, thus, variations may be made thereto without departing from the spirit and scope of the invention as defined in the appended claims.

1-3. (canceled)

4. A method of tracking objects in a geographical area having one or more roadways, the method comprising:
receiving a first set of sensor cluster data from a plurality of radar sensors mounted in the geographical area, the first set of sensor cluster data comprising reflections from a static object in the geographical area;
identifying a position of the static object in the geographical area based on the reflections from the static object in the first set of sensor cluster data;
receiving a second set of sensor cluster data from the plurality of radar sensors, the second set of sensor cluster data comprising reflections from the static object and reflections from a moving object in the geographical area;
identifying a position of the moving object in the geographical area based on the reflections from the moving object in the second set of sensor cluster data;
determining that the position of the static object is the same as the position of the moving object in the geographical area;
filtering out the reflections from the static object from the second set of cluster data; and
tracking the moving object using the filtered second sensor cluster data.

5. The method of claim 4, wherein identifying the position of the static object comprises:
generating a heat map based on the first set of sensor cluster data;
identifying zero speed sensor cluster data in the heat map from among the first set of sensor cluster data;
identifying the position of the static object based on the zero speed sensor cluster data.

6. The method of claim 5, wherein identifying the zero speed sensor cluster data comprises:
determining static speed sensor cluster data in the heat map over a predetermined period of time; and
identifying the zero speed sensor cluster data as the static speed sensor cluster data.

7. The method of claim 6, wherein identifying the zero speed sensor cluster data further comprises outputting a static region corresponding to the static speed sensor cluster data, the static region comprising at least one of a range, an angle, a standard deviation, and a radar cross section of the static region with respect to each radar sensor among the plurality of radar sensors.

8. The method of claim 4, wherein the tracking comprises creating an object list comprising the static object and the moving object, the object list comprising attributes of the static object and attributes of the moving object, and
wherein the filtering comprises filtering radar cluster data of the static object from among the second set of radar cluster data based on the object list.

9. An object tracking system comprising:
a hardware processing unit; and
non-transitory memory coupled to the hardware processing unit, the memory storing program code having instructions which, when executed by the hardware processing unit, cause the hardware processing unit to perform a method of tracking objects in a geographical area having one or more roadways, the method comprising:
receiving a first set of sensor cluster data from a plurality of radar sensors mounted in the geographical area, the first set of sensor cluster data comprising reflections from a static object in the geographical area;
identifying a position of the static object in the geographical area based on the reflections from the static object in the first set of sensor cluster data;
receiving a second set of sensor cluster data from the plurality of radar sensors, the second set of sensor cluster data comprising reflections from the static object and reflections from a moving object in the geographical area;
identifying a position of the moving object in the geographical area based on the reflections from the moving object in the second set of sensor cluster data;
determining that the position of the static object is the same as the position of the moving object in the geographical area;
filtering out the reflections from the static object from the second set of cluster data; and
tracking the moving object using the filtered second sensor cluster data.

10. The object tracking system of claim 9, wherein identifying the position of the static object comprises:
generating a heat map based on the first set of sensor cluster data;
identifying zero speed sensor cluster data in the heat map from among the first set of sensor cluster data;
identifying the position of the static object based on the zero speed sensor cluster data.

11. The object tracking system of claim 10, wherein identifying the zero speed sensor cluster data comprises:
determining static speed sensor cluster data in the heat map over a predetermined period of time; and
identifying the zero speed sensor cluster data as the static speed sensor cluster data.

12. The object tracking system of claim 11, wherein identifying the zero speed sensor cluster data further comprises outputting a static region corresponding to the static speed sensor cluster data, the static region comprising at least one of a range, an angle, a standard deviation, and a radar cross section of the static region with respect to each radar sensor among the plurality of radar sensors.

13. The object tracking system of claim 9, wherein the tracking comprises creating an object list comprising the static object and the moving object, the object list comprising attributes of the static object and attributes of the moving object, and
wherein the filtering comprises filtering radar cluster data of the static object from among the second set of radar cluster data based on the object list.
